(19) United States
(12) Patent Application Publication
(10) Pub. No.: US 2017/0069412 A1
(43) Pub. Date: Mar. 9, 2017

(54) LIGAND PASSIVATED CORE-SHELL FEPT@CO NANOMAGNETS EXHIBITING ENHANCED ENERGY PRODUCT

(71) Applicant: The Florida State University Research Foundation, Inc., Tallahassee, FL (US)

(72) Inventors: Geoffrey F. Strouse, Tallahassee, FL (US); Michael Shatruk, Tallahassee, FL (US); David J. Carnevale, Tallahassee, FL (US)

(21) Appl. No.: 15/255,252

(22) Filed: Sep. 2, 2016

Related U.S. Application Data
(60) Provisional application No. 62/215,374, filed on Sep. 8, 2015.

(51) Int. Cl. H01F 1/03; C22C 5/04; B82Y 40/00; B22F 1/02; B22F 1/00; B82Y 30/00; H01F 7/02; B22F 9/24

(52) U.S. Cl. CPC H01F 1/0306; H01F 7/021; C22C 5/04; B22F 9/24; B22F 1/025; B22F 1/0018; B22F 1/0048; B82Y 30/00; B82Y 40/00; B22F 2009/245; B22F 2202/11; B22F 2302/45; B22F 2301/15

(57) ABSTRACT

A one-pot microwave synthesis of Fe_{0.65}Pt_{0.35}@Co allows systematic growth of the soft-magnet Co shell (0.6 nm to 2.7 nm thick) around the hard-magnet Fe_{0.65}Pt_{0.35} core (5 nm in diameter). Controlled growth leads to a four-fold enhancement in energy product of the core-shell assembly as compared to the energy product of bare Fe_{0.65}Pt_{0.35} cores. The simultaneous enhancement of coercivity and saturation moment reflects the onset of theoretically predicted exchange spring behavior. The demonstration of nanoscale exchange-spring magnets will result in improved high-performance magnet design for energy applications.

### CROSS REFERENCE TO RELATED APPLICATION(S)

This application claims priority to U.S. provisional application Ser. No. 62/215,374, filed Sep. 8, 2015, the disclosure of which is hereby incorporated by reference as if set forth in its entirety.

### STATEMENT REGARDING FEDERALLY SPONSORED RESEARCH OR DEVELOPMENT

This invention was made with Government support under Grant DMR-1507233 awarded by the National Science Foundation. Certain work was done in the National High Magnetic Field Laboratory, which is supported by the National Science Foundation Cooperative Agreement DMR-1157490. The Government has certain rights in the invention.

### FIELD OF THE INVENTION

The present invention relates to magnetic structures, and more particularly to magnetic structures comprising core-shell architecture.

### BACKGROUND OF THE INVENTION

High performance magnets are critical components in energy technologies for rotors and magnetic bearings in motors. Growing awareness of economic limitations associated with rare-earth containing materials has stimulated innovative research efforts to replace rare-earth based magnets with more sustainable alternatives. See O. Gutfleisch, M. A. Willard, E. Brück, C. H. Chen, S. G. Sankar, J. P. Liu, Adv. Mater. 2011, 23, 821-842. Consequently, a grand challenge for energy applications of magnetic materials is the development of controlled architectures of nanoscale magnetic composites that outperform current technologies by reducing rare-earth content while affording comparable or larger energy products. Current energy needs require magnets that are capable of maintaining coercivities of 0.5 to 2 T (Tesla) at elevated temperatures. In order to meet these requirements, current magnets incorporate rare-earth metals, such as Nd₂Fe₁₄B, that result in energy products >60 MGOe (megaGauss Oersteds). See M. S. Walmer, C. H. Chen, M. H. Walmer, IEEE Trans. Magn. 2000, 36, 3376-3381. It has been postulated that patterned nanocomposites consisting of hard and soft magnetic domains can achieve a 6-fold improvement in energy product over the simple hard magnet due to magnetic exchange behavior at the nanoscale. See R. Skomski, J. M. D. Coey; Phys. Rev. B 1993, 48, 15812. Assembled in a controlled fashion, such nanocomposites will offer an opportunity to alter the approach to high-performance magnet design by reducing rare earth content, enhancing remanence without lowering coercivity, and allowing facile composite manufacturing. It is the controlled assembly, however, that is currently lacking in the study of such hard-soft magnetic composites. While multilayer films of hard and soft magnets have been successfully demonstrated and extensively investigated, achieving the same level of control at the nanoparticle scale has proven to be challenging, with only a handful of successful approaches reported in the literature. See a) A. C. Sun, P. C. Kuo, J. H. Hsu, H. L. Huang, J. M. Sun; J. Appl. Phys. 2005, 98, 076109; b) J. U. Thiele. S. Maat, E. E. Fullerton; Appl. Phys. Lett. 2003, 82, 2859; c) Y. Rheem, H. Saito, S. Ishio; IEEE Trans. Magn. 2005, 41, 3793; d) H. Zeng, J. Li, J. P. Liu, Z. L. Wang, S. Sun; Nature 2002, 420, 396; e) H. Akbari, S. A. Sebt, H. Arabi, H. Zeynali, M. Elahi; Chem. Phys. Lett. 2012, 524, 78; f) J. S. Son, J. S. Lee, E. V. Shevchenko, D. V. Talapin; J. Phys. Chem. Lett. 2013, 4, 1918.

Hawig and Kneller coined the idea of exchange-spring magnets, based upon the earlier suggestion by Goto that the exchange interaction between the hard and soft magnetic layers results in a helical arrangement of moments in the soft layer over twice the domain wall width. See E. F. Kneller, R. Hawig, IEEE Trans. Magn. 1991, 27, 3588-3600; and E. Goto, N. Hayashi, Miyashit.T, K. Nakagawa, J. Appl. Phys. 1965, 36, 2951-2958. Skomski and Coey theoretically showed energy products could be increased by 6-fold for a Sm₂Fe₁₇N₃ (hard)-FeCo (soft) ordered composite. In order to achieve the highest performance in colloidal nanocomposites, the soft magnet exchange coupling constant will dictate the shell thickness, roughly a single domain wall width, while the magnitude of the coercivity is governed by use of a single-domain hard magnet. The preparation of hard-soft magnetic nanocomposites has been performed by both mechanical and chemical methods. Ball-milling is one of the most commonly used mechanical approaches, but it leads to grain boundaries and irregularities in the final materials, resulting in rather insignificant, if any, enhancement of the energy product. See a) Y. Hou, S. Sun, C. Rong, J. P. Liu, Appl. Phys. Lett. 2007, 91, 153117; b) X. Q. Liu, S. H. He, J. M. Qiu, J. P. Wang, Appl. Phys. Lett. 2011, 98, 222507; c) P. G. Bercoff, H. R. Bertorello, J. Magn. Magn. Mater. 1998, 187, 169-176; d) J. M. Soares, V. B. Galdino, O. L. A. Conceição, M. A. Morales, J. H. de Araújo, F. L. A. Machado, J. Magn. Magn. Mater. 2013, 326, 81-84. In contrast, chemical approaches often require an intermediate annealing step to make the hard component, causing issues with controlling size dispersion as well as making it difficult to get the nanoparticles back into solution. See a) H. Zeng, J. Li, J. P. Liu, Z. L. Wang, S. H. Sun, Nature 2002, 420, 395-398; b) H. Akbari, S. A. Sebt, H. Arabi, H. Zeynali, M. Elahi, Chem. Phys. Lett. 2012, 524, 78-83. Sun et al. have achieved the most significant results to date through the use of colloidal synthetic approaches based upon successive ionic layer adsorption and reaction (SILAR) to prepare a series of hard-soft core@shell materials that consisted of 4 to 9.5 nm thick Co shells (soft magnet) on 8 nm face-centered tetragonal (fct) FePt particles (hard magnet); the isolated materials, however, did not exhibit the enhanced energy product expected from the theoretical models due to the observed loss of coercivity with increasing shell thickness. See F. Liu, J. H. Zhu, W. L. Yang, Y. H. Dong, Y. L. Hou, C. Z. Zhang, H. Yin, S. H. Sun, Angew. Chem. Int. Ed. 2014, 53, 2176-2180. While the idea of exchange-spring behavior in core@shell nanomagnets has been purported, the observation of the evolution from exchange-coupled to uncoupled behavior in hard-soft nanomagnet composites, as the shell layer grows, still awaits experimental confirmation, reflecting the difficulty to control structural order and shape in nanoscale magnets.

### SUMMARY OF THE INVENTION

Among the provisions of the present invention may be noted an article comprising: a core region comprising an alloy of iron and platinum; and a shell region in contact with the core region, the shell region comprising cobalt.

The present invention is further directed to a magnet comprising a hard magnetic core region and a soft magnetic shell region, wherein the hard-magnet core region comprises and alloy of iron and platinum has the general formula Fe₁₋ₓPtₓ, wherein x has a value between about 0.3 and about 0.7, and the soft-magnet shell region comprises cobalt.

The present invention is still further directed to a method of preparing a particle, the particle comprising a core region comprising an alloy of iron and platinum and a shell region comprising cobalt in contact with the core region, the shell region comprising cobalt, the method comprising: preparing a mixture comprising a platinum precursor, an iron precursor, and an organic solvent system; irradiating the mixture with microwave radiation, to thereby prepare the core region comprising the alloy of iron and platinum; adding a cobalt precursor to the mixture; and irradiating the mixture with microwave radiation to thereby deposit cobalt on the core region comprising the alloy of iron and platinum and to form the shell region comprising cobalt.

The present invention is still further directed to a method of preparing a particle, the particle comprising a core region comprising an alloy of iron and platinum and a shell region comprising cobalt in contact with the core region, the shell region comprising cobalt, the method comprising: contacting a core particle comprising an alloy or iron and platinum with a cobalt precursor in a solvent; and irradiating the formed magnetic core with microwave radiation to thereby deposit cobalt on the core particle comprising the alloy of iron and platinum and to form the shell region comprising cobalt.

Other objects and features will be in part apparent and in part pointed out hereinafter.

### BRIEF DESCRIPTION OF THE DRAWING(S)

FIGS. 1A through 1F are HR-TEM images of the Fe_{0.65}Pt_{0.35} cores (FIGS. 1A and 1B); the core-shell particles additionally comprising the 1.2 nm cobalt shell (FIGS. 1C and 1D); and the core-shell particles additionally comprising the 2.7 nm cobalt shell (FIGS. 1E and 1F). The d-spacing markers are provided in the indicated phases, fcc-FePt (core in FIGS. 1B, 1D, and 1F, labelled as “A”); epitaxial, ε-Co (inner shell region in FIGS. 1D and 1F, labelled as “B”); and fcc-Co (outer shell region in FIG. 1F, labelled as “C”).

FIGS. 2A through 2G provide pictograms (left), HR-TEM images (center) and corresponding field sweeps (right) of the fcc-FePt@Co core-shell nanoparticles (diameter of 5 nm), in the order of the increasing Co shell thickness: 0 nm (FIG. 2A); 0.6 nm (FIG. 2B); 1.0 nm (FIG. 2C); 1.2 nm (FIG. 2D); 1.7 nm (FIG. 2E); 2.0 nm (FIG. 2F); and 2.7 nm (FIG. 2G). TEM images are on dropcast samples from toluene, 200 mesh copper grids at 200 kV.

FIG. 3 is the infrared spectra of 4.9 nm FePt nanoparticles showing that oleylamine (˜1400 cm⁻¹, br) and oleic acid (˜1520 cm⁻¹, m) are present on the surface. The peaks at ˜2900 cm⁻¹ and 2850 cm⁻¹ are indicative of both ligands.

FIG. 4 is a graph of the dielectric spectroscopy of oleylamine/oleic acid mixtures (ε′ ( [symbol] ), ε″ ( [symbol] ), and tan δ ( [symbol] )).

FIGS. 5A and 5B are pXRD patterns of products obtained after reactions attempted to obtain FePt@Co core-shell nanoparticles in a round bottom vessel at 300° C. (FIG. 5A) and 150° C. (FIG. 5B). The sharper peaks observed for products obtained at 150° C. are indicative of Oswald ripening to form larger particles. The shoulders that are observed for products of the 300° C. reaction around 2θ=43° and 48° indicate the nucleation of CoPt nanoparticles, rather than shelling of the FePt nanoparticles.

FIGS. 6A and 6B are thermogravimetric analysis (TGA) (thin lines, y-axis on the left) and differential scanning calorimetry (DSC) (thick lines, y-axis on the right) curves measured on the Fe_{0.65}Pt_{0.35} cores (FIG. 6A) and the Fe_{0.65}Pt_{0.35}@Co nanoparticles with 1 nm thick Co shell (FIG. 6B).

FIGS. 7A through 7E demonstrate the dependence of magnetic parameters on Co shell thickness: saturation magnetization, Mₛ (FIG. 7A); coercive field, H_{c}, (FIG. 7B); % remanent magnetization recovery, η, (FIG. 7C); energy product, BH, (FIG. 7D); and anisotropy constant, K_{eff}, (FIG. 7E). The vertical lines through the middle of each figure delineate the region of maximum exchange-spring effect.

FIG. 8A depicts a diagram of proposed magnetic exchange regimes that occurs within the core-shell nanoparticles. FIG. 8B depicts hysteresis loops for FePt@Co nanoparticles with different Co shell thicknesses.

### DETAILED DESCRIPTION OF THE EMBODIMENT(S) OF THE INVENTION

The present invention is directed to a nanomagnet comprising core-shell architecture. In some exemplary, non-limiting embodiments, we demonstrate the synthesis of FePt@Co, e.g., Fe_{0.65}Pt_{0.35}@Co, nanomagnets by one-pot microwave (MW) chemistry methods. According to the present invention, the material located before the “@” signifies the core material in a particle, and the material located after the “@” signifies the shell material in a particle. Accordingly, Fe_{0.65}Pt_{0.35}@Co defines a material comprising a Fe_{0.65}Pt_{0.35} core and a Co shell. In some exemplary, non-limiting embodiments, the Co shell of variable thickness was grown onto 4.9±0.6 nm fcc-Fe_{0.65}Pt_{0.35} core. As the shell thickness increases, the theoretically predicted evolution from exchange-coupled to exchange-spring and finally to magnetically decoupled behavior in the hard-soft nanocomposite is observed for the first time. Correlating the change in saturation magnetization (Mₛₐₜ), coercivity (H_{c}), remanent magnetization recovery (η), and energy product (BH) across the observed magnetic regimes results in a surprising observation, namely at shell thicknesses ≦1 nm, the core-shell nanostructure provides an unexpected doubling of the coercivity, generating a dramatic enhancement in the energy product from 1.1 MGOe (megaGauss Oersteds) for the bare Fe_{0.65}Pt_{0.35} nanoparticles to 3.8 MGOe (megaGauss Oersteds) for the Fe_{0.65}Pt_{0.35}@Co nanocomposite. By increasing the shell thickness to 1.7 nm, the exchange-spring effect is maximized, resulting in a remanant magnetization recovery of η=75% from the coercive point. Loss of exchange spring behavior is observed as the Co layer grows thicker due to magnetic decoupling at the subsequent layers. We emphasize that the fcc-Fe_{0.65}Pt_{0.35}@Co core-shell nanomagnet described in this study represents the first synthetic model system to interrogate the onset of exchange-spring behavior and not a material for direct energy applications, although rather high coercivity of 0.575 T was observed. The choice of the fcc-FePt as a model hard core avoids the diffusion of Co into the particle core that could take place during the thermal treatment needed to produce magnetically harder fct-FePt. The evolution of the exchange-spring magnet behavior in these core@shell nanomagnets occurs over the length scale equivalent to the domain wall width of the soft magnet, consistent with the theoretical predictions.

In some embodiments, the present invention is directed to an article comprising a core region comprising an alloy of iron and platinum and a shell region in contact with the core region, the shell region comprising cobalt. In some embodiments, the present invention is directed to an article comprising a core region consisting essentially of an alloy of iron and platinum and a shell region in contact with the core region, the shell region consisting essentially cobalt. In some embodiments, the present invention is directed to an article comprising a core region consisting an alloy of iron and platinum and a shell region in contact with the core region, the shell region consisting of cobalt. The article, e.g., a particle and more specifically a nanoparticle, may be synthesized using a microwave method. The microwave method advantageously enables control of the deposition of the shell material, such as by layering monoatomic thick layers, which thereby controls the thickness and uniformity of the deposition shell region comprising cobalt.

In some embodiments, the cobalt shell is deposited an atomic monolayer at a time, in order to control the shell thickness and thickness uniformity. In some embodiments, the cobalt is deposited onto the core region comprising the alloy of iron and platinum in a layer by layer method, wherein each layer is between about 0.3 nanometer and about 0.7 nanometer thick. In some embodiments, the cobalt is deposited onto the core region comprising the alloy of iron and platinum in a layer by layer method, wherein each layer is about 0.5 nanometer thick. By layering to build up the shell comprising cobalt, the energy product of the FePt@Co core-shell nanoparticles increased dramatically as compared to the bare FePt cores. According to known methods, the thinnest Co shell reported was 4 nm thick, which is far beyond the exchange-spring regime. In some embodiments, the shell prepared according to the method of the present invention may be about 1 nanometer or thinner to observe the increase in the energy product.

Microwave radiation is capable of selectively targeting and heating the precursors and resulting cores directly, rather than increasing the temperature via the solvent-mediated heat transfer as happens in conventional heating. This targeted heating drives the shelling reaction to occur directly at the surface of the formed FePt, e.g., Fe_{0.65}Pt_{0.35}, cores. The reaction vessel is maintained at lower temperature by using air flow along the sides of the vessel. The shell thickness is controlled by the amount of the Co precursor that is added slowly. Accordingly, the shell material is built up on a nanoscale in terms of lattice reconstruction in the interfacial regions, thereby additionally reducing possible dislocation and lattice mismatch defects, etc.

The core particle, e.g., core nanoparticle comprises an alloy of iron and platinum. In some embodiments, the core region consists essentially of an alloy of iron and platinum. In some embodiments, the core region consists of an alloy of iron and platinum. In some embodiments, the core region comprises an alloy of iron and platinum, which has the general formula Fe₁₋ₓPtₓ, wherein x has a value between about 0.3 and about 0.7, or between about 0.3 and about 0.4. In some embodiments, the alloy of iron and platinum has the general formula Fe_{0.65}Pt_{0.35}. The method of preparing the core particle, e.g., nanoparticle, results in a crystalline form, which may be face centered cubic crystals or face centered tetragonal crystals. In some embodiments, face centered cubic (fcc) crystals are preferred. The core particle may be in a shape selected from among sphere, bar, cone, sheet, and rod. In some preferred embodiments, the core particle, e.g., nanoparticle comprises a sphere, and the core region has a diameter between about 2 nanometers and about 10 nanometers, or between about 2 nanometers and about 8 nanometers, such as between about 4 nanometers and about 6 nanometers, such as about 4 nanometers, about 5 nanometers, or about 6 nanometers. In some preferred embodiments, the present invention is directed to a population of articles, each article comprising core particle, e.g., nanoparticle comprises a sphere, and the core particles within the population of articles has an average diameter between about 2 nanometers and about 10 nanometers, or between about 2 nanometers and about 8 nanometers, such as between about 4 nanometers and about 6 nanometers, such as about 4 nanometers, about 5 nanometers, or about 6 nanometers.

The method of the present invention further comprises depositing a shell region comprising cobalt on the core region. Accordingly, in some embodiments, the article of the present invention comprise a core region and a shell region comprising cobalt. A preferred article comprise a spherical particle comprising a core region and a shell region, wherein the shell region comprising cobalt has a thickness between about 0.2 nanometers and about 5 nanometers, as measured perpendicularly from a point at the interface between the core particle and the shell toward a point on the surface of the shell, such as between about 0.3 nanometers and about 4.0 nanometers, or between about 0.5 nanometers and about 2.5 nanometers. In some embodiments, the shell region has a thickness between about 0.5 nanometers and about 1.0 nanometers. In some embodiments, the present invention is directed to a population of articles, each article comprising a spherical particle comprising a core region and a shell region, wherein the shell regions within the population of articles has an average thickness between about 0.2 nanometers and about 5 nanometers, as measured perpendicularly from a point at the interface between the core particle and the shell toward a point on the surface of the shell, such as between about 0.3 nanometers and about 4.0 nanometers, or between about 0.5 nanometers and about 2.5 nanometers. In some embodiments, the shell region has an average thickness between about 0.5 nanometers and about 1.0 nanometers.

In some embodiments, the articles of the present invention comprise a magnet comprising a hard magnet core region and a soft magnet shell region, wherein the hard magnet core region comprises and alloy of iron and platinum has the general formula Fe₁₋ₓPtₓ, wherein x has a value between about 0.3 and about 0.7, and the soft magnet shell region comprises cobalt.

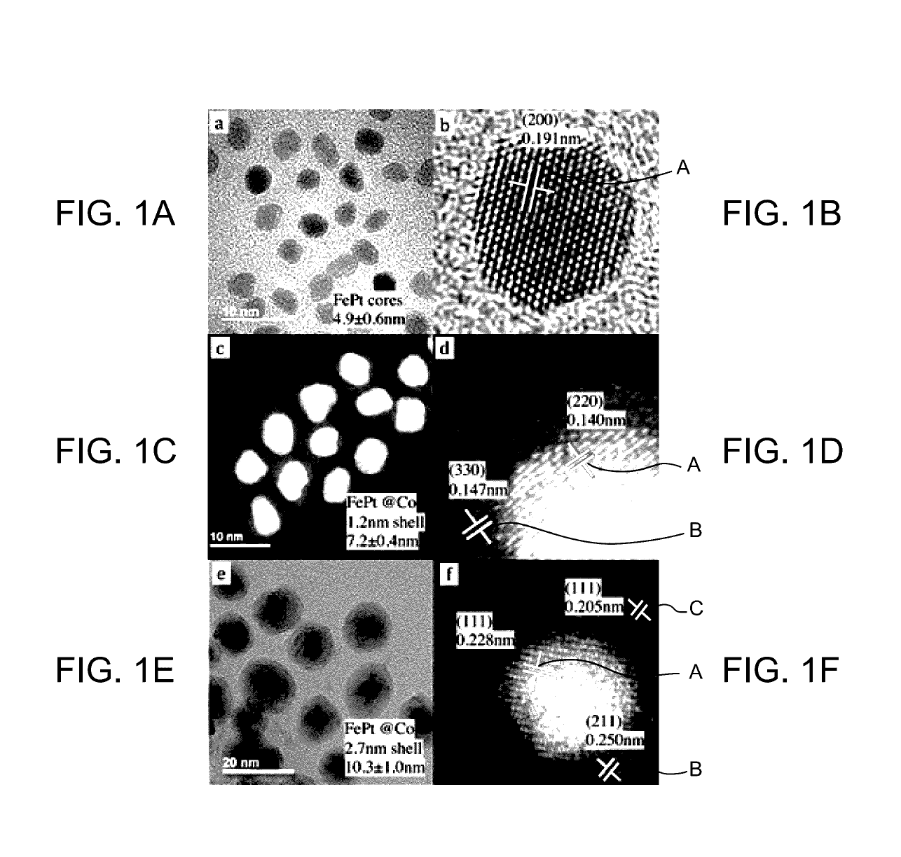

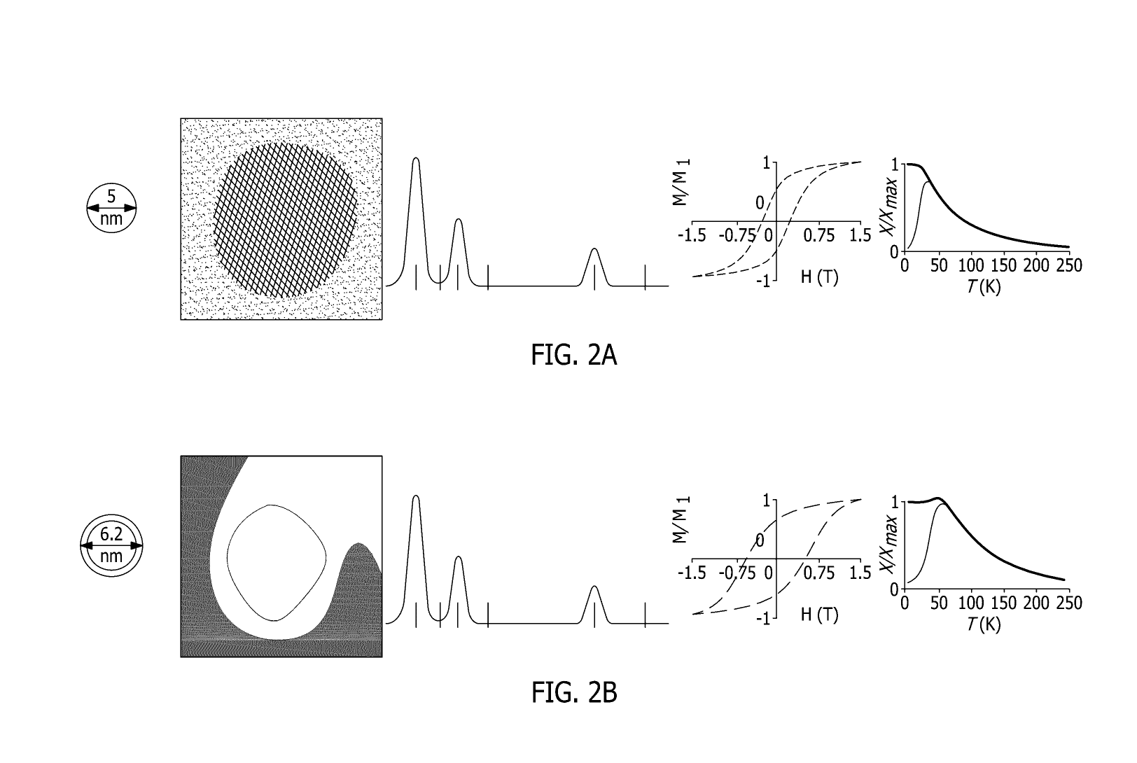

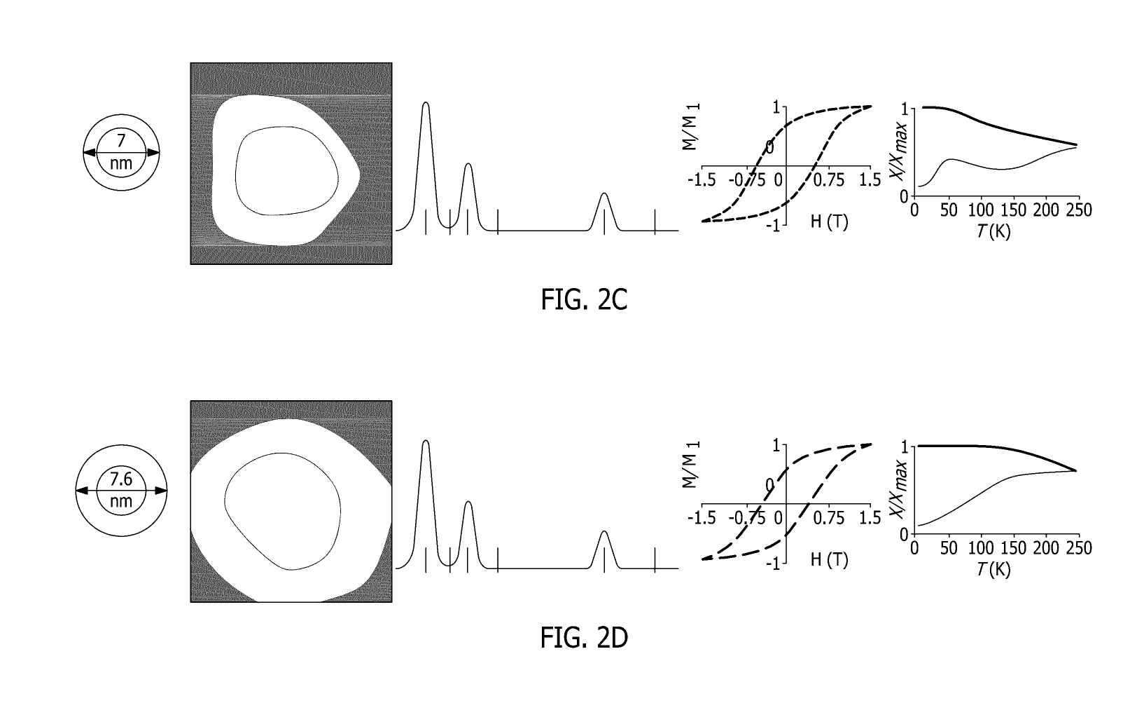

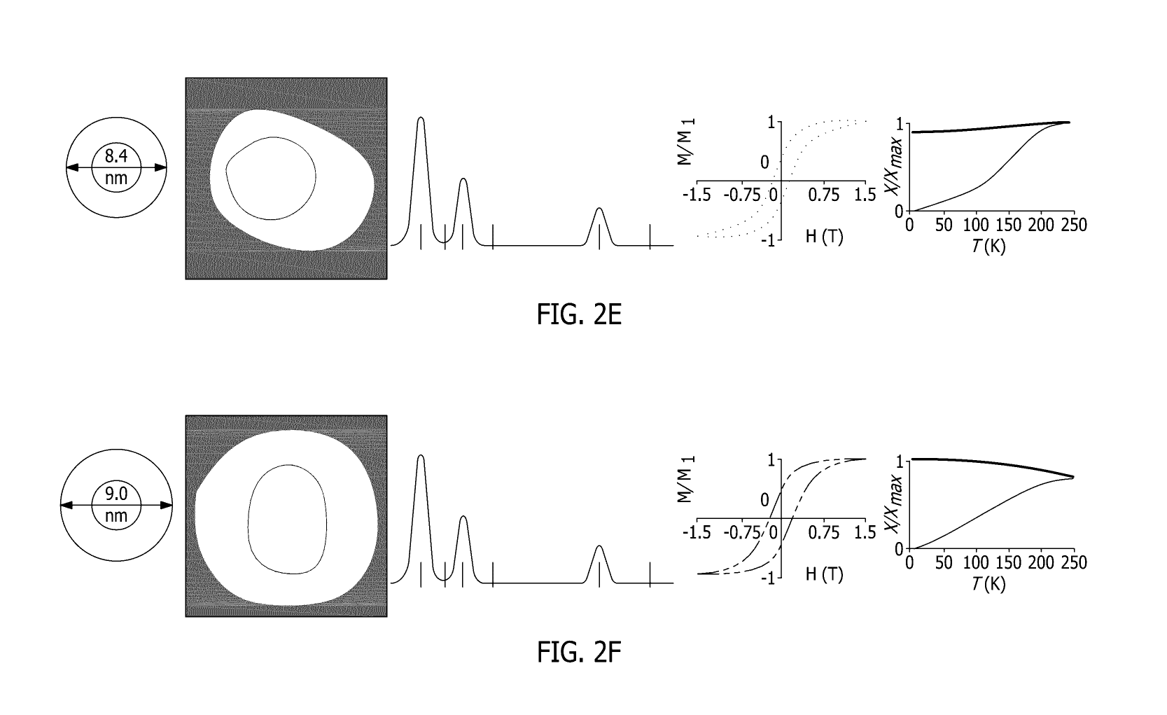

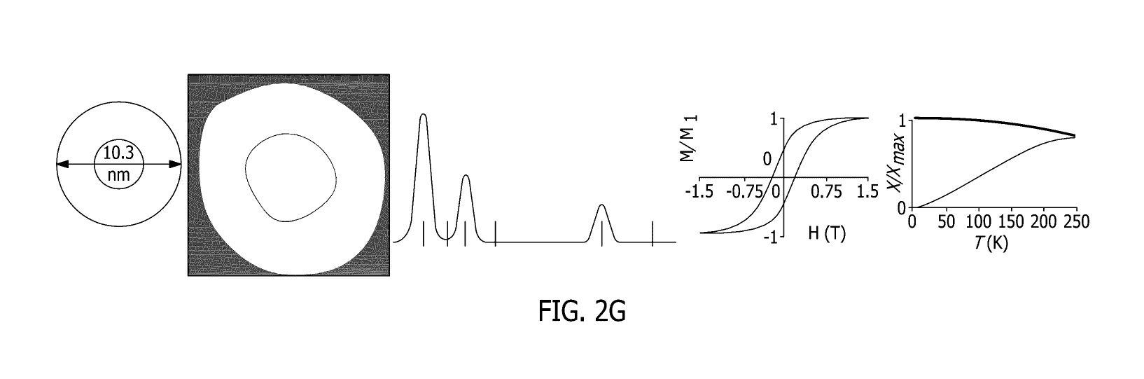

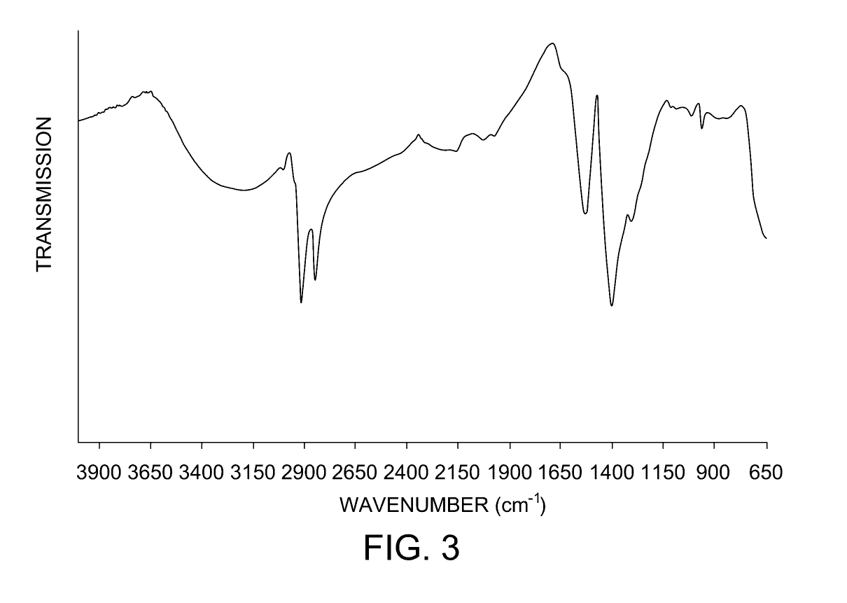

The successive ionic layer adsorption and reaction (SILAR) protocol was adapted to microwave (MW) reactor through the use of high temperature reduction of the molecular precursors Pt(acac)₂, Fe(CO)₅, and Co(acac)₂ in oleylamine/oleic acid, carried out under a N₂ atmosphere. Formation of the core within the MW cavity (CEM Explorer, 2.45 GHz, 300 W) is achieved at 150° C. within 5 minutes, producing the spherical 4.9±0.6 nm fcc-Fe_{0.65}Pt_{0.35} cores. See FIGS. 1A and 1B. Successive addition of the Co precursor is continued at temperatures between about 150° C. and about 160° C., which is well below the 240° C. nucleation temperature of Co nanocrystals, leading to epitaxial growth of an ε-Co shell (0.6 nm to 2.7 nm). See FIGS. 1C and 1D. This is followed by continued addition of Co precursor, thereby yielding face centered cubic (fcc) crystals in the outer shell region. See FIGS. 1E and 1F. High-resolution TEM images indicate the resulting nanoparticles are spherical, with no evidence of phase-segregated FePt or Co nanocrystals or Janus type composites present in the isolated materials. See FIGS. 2A through 2G. ICP-MS measurements of the nanocrystals show the Fe:Pt ratio is ˜65:35 for all samples. See Table 1. The isolated core@shell nanocomposite is passivated by a mix of acetylacetonate, oleylamine, and oleic acid, as confirmed by characteristic bands observed in FT-IR spectra. See FIG. 3.

TABLE 1
Results of ICP-MS analysis of Fe:Pt ratio in the nanoparticles.

| Shell | Core composition | | Core/shell composition | | |
|---|---|---|---|---|---|
| thickness | Fe mol % | Pt mol % | Fe mol % | Pt mol % | Co mol % |
| 0 nm | 65% | 35% | 65% | 35% | 0% |
| 0.6 nm | 65% | 35% | 47% | 25% | 27% |
| 1.0 nm | 64% | 36% | 40% | 23% | 37% |
| 1.2 nm | 66% | 34% | 29% | 15% | 56% |
| 1.7 nm | 68% | 32% | 25% | 13% | 62% |
| 2.0 nm | 65% | 35% | 18% | 10% | 72% |
| 2.3 nm | 60% | 40% | 8% | 5% | 87% |

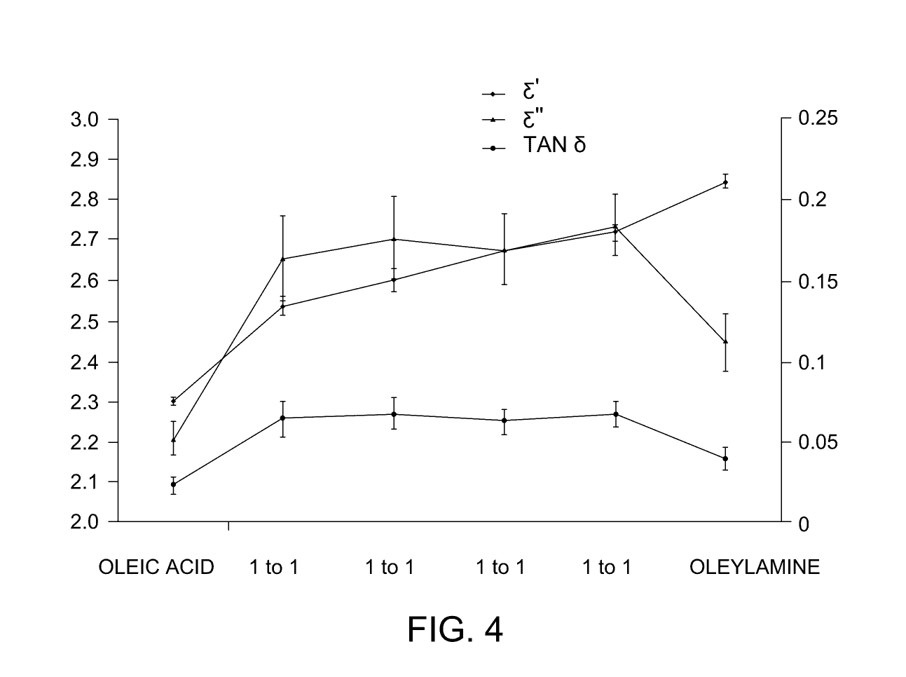

The use of oleylamine/oleic acid solvent mixture rather than only oleylamine is required to enhance microwave (MW) absorption by the reaction medium to afford rapid volumetric heating of the reaction mixture, uniform nucleation, and rapid depletion of the monomer concentrations to achieve size focusing, as previously reported for metal chalcogenide nanocrystals grown in a MW reactor. See A. L. Washington, G. F. Strouse; J. Am. Chem. Soc. 2008, 130, 8916. The enhanced MW absorption from the 4:1 oleylamine/oleic acid solvent mixture is demonstrated by high-frequency dielectric spectroscopy. See FIG. 4. No observation of acac decomposition to form oxides is observed under the reaction conditions, reflecting the lower reaction temperatures and the reducing environment.

The crystal phase of the core and core@shell nanocrystals was analyzed by measuring the lattice fringes in high-resolution TEM images. See FIGS. 1A through 1F. The assignments were confirmed by powder X-ray diffraction (pXRD). See FIGS. 2A through 2G. The pXRD analysis shows the core is comprised of fcc-FePt, which was confirmed by identifying the corresponding (200), (220), and (111) lattice planes in the TEM images. See FIGS. 1A through 1C. In the low-resolution TEM and STEM images, the Co shell is observed to grow uniformly onto the FePt core. Assignment of lattice fringes for the 1.2 nm Co shell suggests the metastable ε-Co (330) plane growing onto the FePt (220) plane. See FIG. 1D. Indexing lattice planes for thicker Co shells (e.g., 2.7 nm) shows that the ε-Co phase relaxes to adopt the fcc-Co structure in the outer shells, resulting in the appearance of both the (211) ε- and (111) fcc-Co lattice planes in FIG. 1F. No change in FePt size or structure is observed in the TEM for all Co shell thicknesses. Both the ε- and fcc-type structures have been reported for lyothermally grown Co nanoparticles, but only the fcc structure has been reported for thick Co shells grown on FePt. See F. Liu, J. H. Zhu, W. L. Yang, Y. H. Dong, Y. L. Hou, C. Z. Zhang, H. Yin, S. H. Sun, Angew. Chem. Int. Ed. 2014, 53, 2176-2180; S. Sun, C. B. Murray, J. Appl. Phys. 1999, 85, 4325-4330; and C. W. Kim, H. G. Cha, Y. H. Kim, A. P. Jadhav, E. S. Ji, D. I. Kang, Y. S. Kang; J. Phys. Chem. C. 2009, 113, 5081. It is believed the observation of the metastable ε-Co phase for shell thicknesses below 1.7 nm reflects interfacial strain and fast crystallization conditions, which lead to the less regular arrangement of Co atoms. Consistent with these arguments, the Co lattice is observed to relax to the fcc structure for the thickest Co shells.

The MW-assisted successive ionic layer adsorption and reaction (SILAR) growth of the nanocomposites, e.g., Fe_{0.65}Pt_{0.35}@Co nanocomposite, produces uniformly sized, highly crystalline structures. In some embodiments, the present invention is directed to a method of preparing a particle, e.g., a nanoparticle, comprising a core region comprising an alloy of iron and platinum and a shell region comprising cobalt in contact with the core region, the shell region comprising cobalt. In some embodiments, the method comprises preparing a mixture comprising a platinum precursor, an iron precursor, and an organic solvent system. The platinum precursor may be a suitable platinum salt or a platinum complex in which the platinum is in cationic form or in its zero valence state. In some embodiments, the platinum precursor may selected from the group consisting of PtCl₂, Pt(NH₃)₄(NO₃)₂, Pt(acac)₂, and any combination thereof. The iron precursor may be a suitable iron salt or an iron complex in which the iron is in cationic form or in its zero valence state. In some embodiments, the iron precursor may selected from the group consisting of Fe(CO)₅, Fe₂(CO)₉, Fe₃(CO)₁₂, and any combination thereof. In some embodiments, the organic solvent may comprise an aprotic solvent. In some embodiments, the organic solvent system may comprise a solvent selected from the group consisting of oleylamine, oleic acid, octadecene, polyvinylpropylene, hexadecylamine, and any combination thereof.

In some embodiments, the mixture is irradiated with microwave radiation to thereby prepare the core region comprising the alloy of iron and platinum. Any of a wide variety of laboratory grade or even commercial grade microwave ovens capable of providing sufficient power to heat the mixture are suitable for use in the present invention. In some embodiments, the frequency of radiation is between about 1 GHz and about 18 GHz, between about 1 GHz and about 6 GHz, between about 1.5 GHz and about 3 GHz, between about 3 GHz and about 6 GHz, between about 6 GHz and about 10 GHz, or between about 14 GHz and about 17 GHz. In some embodiments, the power of the microwave radiation may be up to about 1500 W, or up to about 1000 W, such as between about 75 W and about 1500 W, or between about 75 W and about 1000 W, or between about 75 W and about 500 W, or between about 75 W and about 200 W. In some preferred embodiments, the microwave power may be at least about 200 W, such as about 300 W.

In some embodiments, after the core particle, e.g., core nanoparticle comprising the alloy of iron and platinum is prepared, a cobalt precursor is added to the reaction mixture. The cobalt precursor may be a suitable cobalt salt or a cobalt complex in which the cobalt is in cationic form or in its zero valence state. In some embodiments, the iron precursor may be selected from the group consisting of Co₂(CO)₈, Co(acac)₂, CoCl₂, and any combination thereof. The mixture is again irradiated with microwave radiation to thereby deposit cobalt on the core region comprising the alloy of iron and platinum and to form the shell region comprising cobalt. In some embodiments, the cobalt is deposited onto the core region comprising the alloy of iron and platinum one atomic monolayer at a time. That is, the cobalt is deposited in a monolayer fashion, which avoids the formation of thicker islands and particles. Accordingly, the variation in layer thickness is minimized. In some embodiments, the cobalt is deposited onto the core region comprising the alloy of iron and platinum in a layer by layer method, wherein each layer is between about 0.3 nanometer and about 0.7 nanometer thick. In some embodiments, the cobalt is deposited onto the core region comprising the alloy of iron and platinum in a layer by layer method, wherein each layer is about 0.5 nanometer thick. In some embodiments, the shell region comprising cobalt has a thickness between about 0.2 nanometers and about 5 nanometers, as measured perpendicularly from a point at the interface between the core particle and the shell toward a point on the surface of the shell, such as between about 0.3 nanometers and about 4.0 nanometers, or between about 0.5 nanometers and about 2.5 nanometers. In some embodiments, the shell region comprising cobalt is less than 3 nanometers thick, as measured perpendicularly from a point on the interface between the core region and the shell region toward a point on the surface of the shell. In some embodiments, the shell region comprising cobalt is less than 2 nanometers thick. In some embodiments, the shell region comprising cobalt is less than 1 nanometer thick.

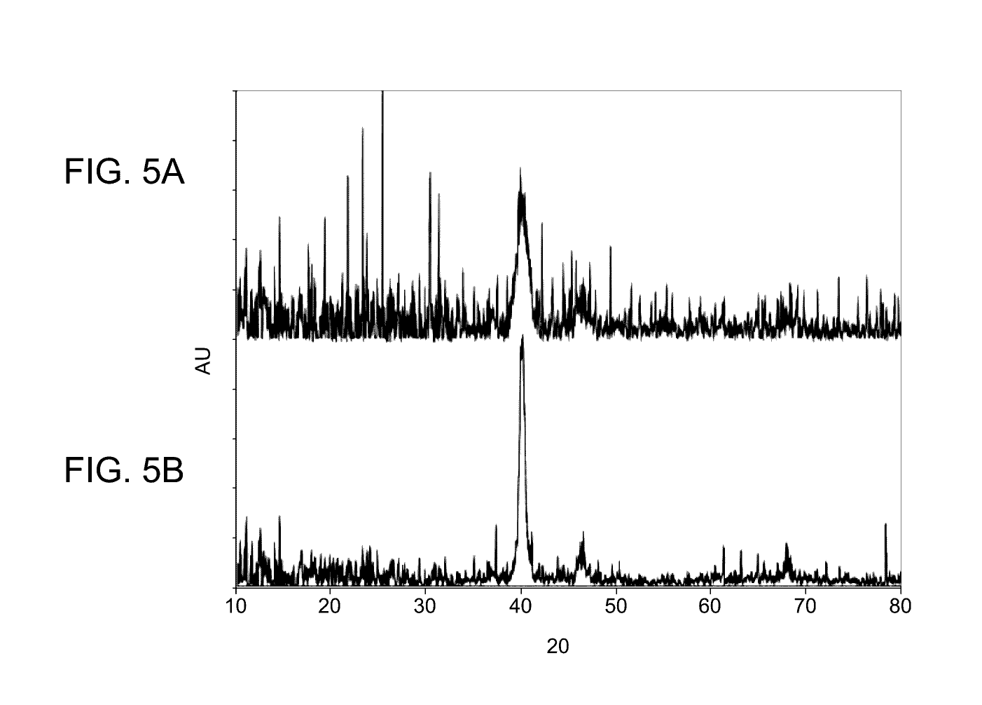

The ability to form narrow size-dispersity cores that can be shelled without complication, avoiding phase segregation of individual Co and FePt components, reflects the known efficiency for nanoparticle formation in a MW reactor due to rapid nucleation through efficient volumetric heating of the oleic acid/oleylamine solvent mixture coupled to La Mer limited growth of the core during the short reaction times (5-10 min). See A. L. Washington, G. F. Strouse; Chem. Mater. 2009, 21, 2770; and K. Kim, R. Oleksak, E. Hostetler, D. Peterson, P. Chandran, D. Schut, B. Paul, G. Herman, C. Chang; Cryst. Growth Des. 2014, 14, 5349. The growth of the Co shell onto the FePt core is observed to occur in a nearly monolayer level fashion, which has not been previously observed. This phenomenon can be explained by the fact that the 150° C. reaction temperature for Co shelling is much lower than the 240° C. solvent temperature required to nucleate individual Co nanoparticles. Thus, MW selectively heats the already formed cores instead of heating the surrounding solvent. Attempts to achieve the same level of control for shelling in a traditional SILAR lyothermal reaction produced non-uniform materials for reactions carried out between 150° C. and 250° C. See FIG. 5. Sun et al. reported that shelling required temperatures over 300° C. in the synthesis of previously reported core-shell materials. See F. Liu, J. H. Zhu, W. L. Yang, Y. H. Dong, Y. L. Hou, C. Z. Zhang, H. Yin, S. H. Sun, Angew. Chem. Int. Ed. 2014, 53, 2176-2180.

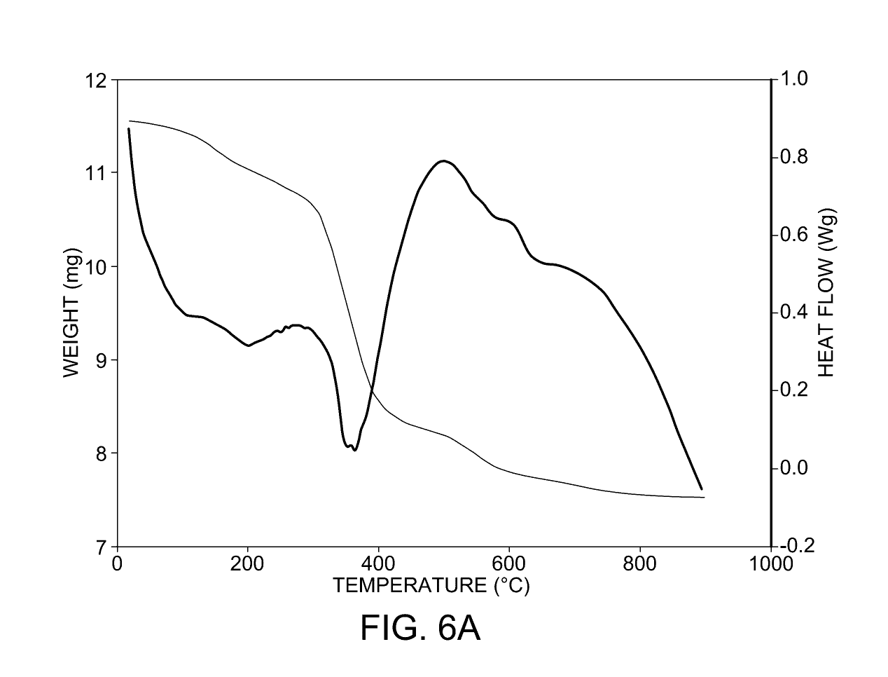

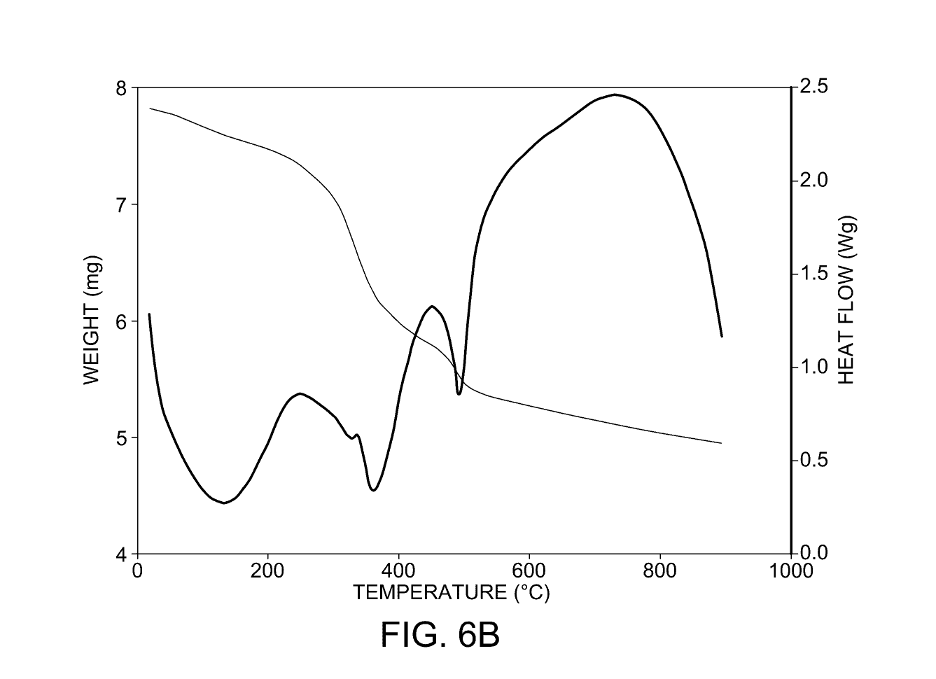

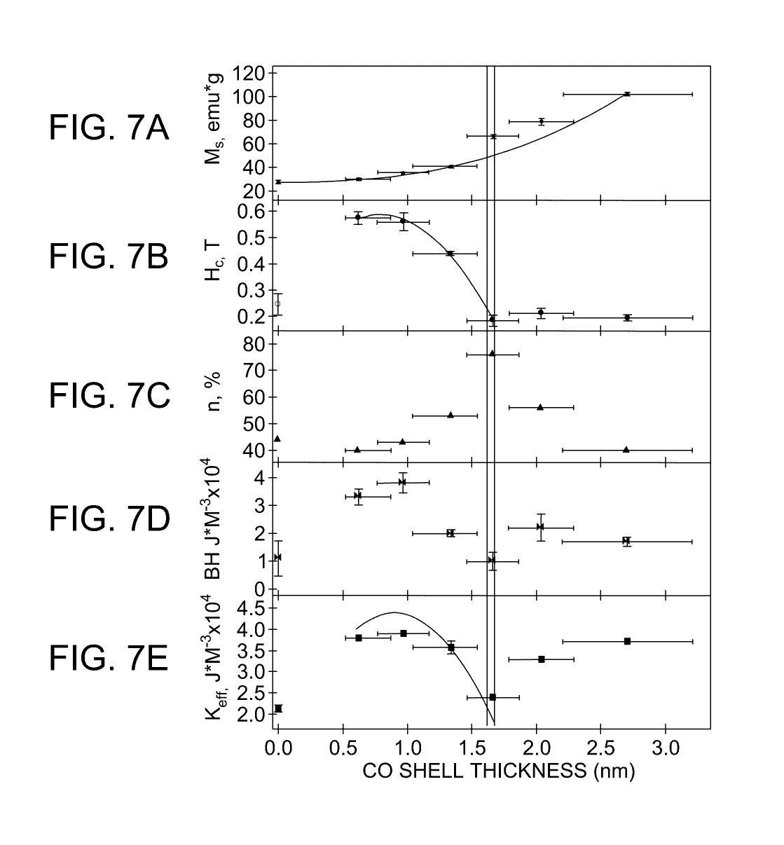

The onset of the exchange regimes for the nanocomposites can be analyzed by inspection of the superconducting quantum interface device (SQUID) magnetization plots of the core@shell samples immobilized in 1-eicosane. See FIGS. 2A through 2G. The zero-field cooled and field cooled temperature dependent magnetization shows the FePt cores to behave as a superparamagnet with blocking temperature (T_{B}) of 35 K. The field-dependent magnetization sweeps performed at 5 K from 2 T to −2 T exhibit a sizable hysteresis, with H_{c}=0.25 T and Mₛₐₜ=20 emu/g after subtracting the ligand mass contribution. The latter was determined from thermogravimetric analysis (TGA) measurements that indicated ligand loss equivalent ˜31(2) wt. % of the core@shell nanocomposite. See FIGS. 6A and 6B. The T_{B}, H_{c} and Mₛₐₜ values for the fcc-Fe_{0.65}Pt_{0.35} core are consistent with values reported for fcc-FePt nanoparticles in this size range. See V. Nandwana, K. E. Elkins, N. Poudyal, G. S. Chaubey, K. Yam, J. P. Liu, J. Phys. Chem. C 2007, 111, 4185-4189. As the Fe_{0.65}Pt_{0.35} core becomes shelled by the Co, the magnetic response of the material changes. The addition of the first Co shell (0.6 nm) leads to the increase in T_{B} to 55 K, an increase in Mₛₐₜ to 22 emu/g, and an increase in H_{c} to 0.58 T. The change in Mₛₐₜ with increasing shell thickness follows a volumetric power scaling law (r³), that is consistent with the increasing volume of Co in the sample. See FIG. 7A. Following the initial large increase in H_{c} for the first layer of Co, the further change in H_{c} is non-linear (FIG. 7B), exhibiting a hyperbolic decrease with an asymptote around 0.2 T for shells thicker than 1.7 nm.

The initial jump in T_{B} is interpreted as exchange pinning of the Co layer that raises the blocking temperature due to the much higher T_{C} of Co compared to that of fcc-Fe_{0.65}Pt_{0.35}. The observed increase in Mₛₐₜ reflects the increasing volume fraction of Co per particle and, therefore, the higher magnetic moment per unit mass for Co relative to FePt. The effect of Co shell thickness on H_{c} is consistent with the expectations for distance-dependent exchange behavior that evolves over a narrow domain wall width. The core-shell magnetic interaction progresses form the exchange-pinned regime, where a jump in H_{c} is expected, to a maximum exchange-spring regime, where the Co shell is ferromagnetically coupled to the hard core, and finally to the magnetically-decoupled regime that should result in a loss of exchange-spring behavior. Thus, as the shell thicknesses exceed the domain wall width, the Co will behave progressively as a soft magnet and dominate the observed magnetic data.

To correlate the observed magnetic data with the predictions for exchange-spring behavior, as defined by Goto, Skomski and Coey, and Hawig and Kneller, the magnetization recovery (FIG. 7C), energy product (FIG. 7D) and anisotropy (FIG. 7E) are presented as a function of shell thickness. The η value for the particles with Co shells thinner than 1 nm is identical to that observed for the pure FePt particles (η˜40%). For the thicker Co shells, however, η is observed to increase, reaching a maximum value of 75% for the particles with 1.7 nm thick Co shell, whereas an ideal exchange-spring magnet should have 100% recovery of Mᵣ when the field is turned off. We note that our findings compare well to the results of demagnetization sweeps performed on CoPt/Co magnetic bilayers, which demonstrated η˜30-75% after the demagnetizing field was turned off. See D. C. Crew, J. Kim, L. H. Lewis, K. Barmak, J. Magn. Magn. Mater. 2001, 233, 257-273. The maximum in the η value is consistent with the predicted exchange-spring behavior and can be interpreted as occurring at approximately the domain wall width, the distance at which Co moments are still significantly coupled to the hard FePt moments. Beyond this limit, the theoretical model predicts loss of exchange spring behavior, as observed in the experimental data.

The evolution of η can be correlated to the anisotropy of the system. The anisotropy value can be calculated as K_{eff}≈2H_{c}μ₀Mₛ, where both H_{c} and Mₛ are measured in A m⁻¹ and μ₀ is the magnetic permittivity constant, 1.26×10⁻⁵ T m A⁻¹. See J. Arcas, A. Hernando, J. M. Barandiaran, C. Prados, M. Vázquez, P. Marin, A. Neuweiler, Phys. Rev. B 1998, 58, 5193-5196. The value of K_{eff} as a function of shell thickness is plotted in FIG. 7E, showing a hyperbolic behavior between 0.6 nm and 1.7 nm Co shell thickness. The calculated K_{eff} of 2.1×10⁻⁵ J m⁻³ for the 4.9 nm Fe_{0.65}Pt_{0.35} cores is comparable to previously reported values. See M. S. Seehra, V. Singh, P. Dutta, S. Neeleshwar, Y. Y. Chen, C. L. Chen, S. W. Chou, C. C. Chen, J. Phys. D 2010, 43, 145002. As the Co shell becomes thicker, the K_{eff} decreases; above 1.7 nm the K_{eff} value approaches that of bulk Co, ˜5×10⁻⁵ J m⁻³.

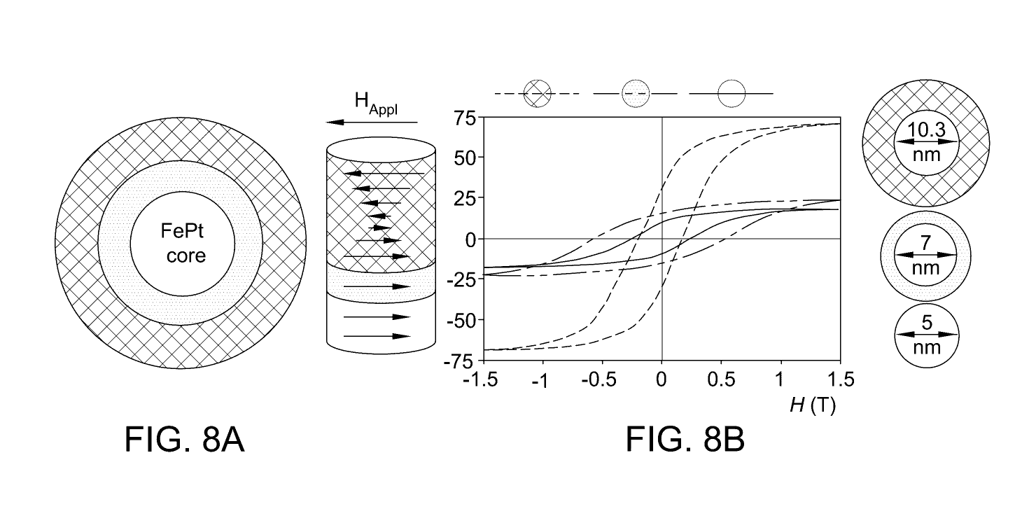

An important measure of magnetic exchange behavior is the observation of increased energy product. The predicted enhancement of BH in exchange-spring systems has been observed in thin-film bilayers and core@shell nanocrystals previously. In the present work, the controlled layering of the Co shell onto the Fe_{0.65}Pt_{0.35} core allows observation of the BH evolution (FIG. 7D). The BH value increases from 1.1 MGOe for the unshelled FePt particles to 3.8 MGOe for the Fe_{0.65}Pt_{0.35}@Co particles with 1.0 nm thick Co shell, and then drops to 2.2 MGOe as the Co shell thickness increases. The changes in BH, Mᵣ, and H_{c} at the same shell thickness are consistent with the Goto model prediction for exchange-spring coupling between the layers arising within the single domain limit of the system. When the distance from the Fe_{0.65}Pt_{0.35}@Co interface exceeds 1.7 nm, the Co moments are no longer coupled to the magnetization of the Fe_{0.65}Pt_{0.35} core and their magnetization is easily switched by the external field. See FIG. 8B.

In summary, by application of MW-assisted SILAR method, a soft magnet Co shell was layered onto a hard magnet FePt core in a controlled manner, to achieve various shell thicknesses. This process allowed, for the first time, the observation of a correlated enhancement of the coercivity and energy product and other size-dependent exchange regimes in a hard-soft nanocomposite system. Based on the magnetic response of these FePt@Co nanocomposites, the evolution of exchange regimes can be described. See FIG. 8A. Although the actual dimensions will be system dependent, the general behavior is believed to be universal in magnetic hard core@soft shell. The change in the magnetic hardness of the composite (H_{c}) can be interpreted within the spin-exchange model if the magnetic subsystem is defined over the entire particle. The assumption of the magnetic behavior being defined by the total system is consistent with the r³ dependence of Mₛₐₜ and the observation of the single T_{B} value for the ≧1 nm Co-shelled particles. Earlier theoretical models predict a gradual transition from exchange-coupled, to exchange-spring, and finally to a decoupled behavior as one moves away from the magnetically hard core into the magnetically soft shell. The initial increase in H_{c} is therefore believed to reflect the hard exchange coupling of the 0.6 nm Co soft shell by the Fe_{0.65}Pt_{0.35} hard core resulting in an increased magnetic anisotropy of the total system and a higher coercivity than that of pure fcc-Fe_{0.65}Pt_{0.35} particles.

To the best of our knowledge, the exchange-coupling of this effect has not been reported previously in the nanoparticle literature, which likely is due to the very short range of such behavior. At very short distances (≦1.0 nm) from the Fe_{0.65}Pt_{0.35}@Co interface, the exchange-pinned Co shell effectively behaves as an extension of the hard FePt core, resulting in the higher H_{c} values, just like one would observe for FePt nanoparticles of a larger size. As the shell thickness increases, the exchange behavior and magnetic response proceed towards a weak exchange regime, where the outer-most moments of the shell are no longer coupled to the core. Previous work on hard-soft nanocomposites supports the notion that this uncoupling of the outer moments in large shells ultimately causes massive losses in the coercivity and generates particles that look more like the soft magnetic materials. Further studies are underway to interrogate the shape and composition effects on the exchange-spring behavior in these colloidally grown hard soft nanocomposites.

### EXAMPLES

The following non-limiting examples are provided to further illustrate the present invention.

### Example 1

### Synthesis

Starting materials. All reagents and solvents were obtained from Aldrich and used as received. The reactions were carried out under inert N₂ atmosphere, unless noted otherwise.

Synthesis of 5 nm Fe_{0.65}Pt_{0.35} cores. A stock solution comprising platinum (Pt) and iron (Fe) was prepared by dissolving 392 mg (1 mmol) of Pt(acac)₂ (acac=acetylacetonate) in 10 mL of oleylamine/oleic acid mixture (4:1 v/v). The stirred solution was degassed under vacuum at 60° C. until it turned dark yellow, at which point the reaction vessel was placed under a N₂ environment. To the Pt stock solution, 776 mg (3 mmol) of 1,2-hexadecanediol (hdd) was added and allowed to dissolve, followed by addition of 332 mg (0.66 mmol) of Fe₃(CO)₁₂ that generated a deep red solution. To form the FePt nanoparticles, 2 mL of the stock solution was added to a 6 mL Pyrex® microwave reactor vessel under N₂, heated to 150° C. for 5 min in a CEM microwave reactor operating at 4.5 GHz single mode, constant 300 W power, and constant temperature via active cooling. After cooling to room temperature, the obtained FePt nanoparticles were isolated by addition of toluene to the mixture followed by drop wise addition of MeOH to induce nanoparticle precipitation from the non-polar organic medium, followed by centrifugation. The remaining product underwent the same washing procedure until the supernatant became clear and colorless. Final purification was accomplished by re-suspension of the precipitate in toluene and separation by use of a Nd—Fe—B magnet to induce particle aggregation. The sample was collected by removal of the supernatant and dried under vacuum.

FePt@Co particles. A stock solution of Co precursor was prepared by dissolving 514 mg (2 mmol) of Co(acac)₂ in 10 mL of oleylamine/oleic acid mixture (4:1 v/v). The solution was degassed under vacuum at 60° C. until a deep purple solution was obtained, at which point the vessel was refilled with N₂. Once the FePt cores formed in the other solution, as described above, the Co solution was added directly into the reaction by a SILAR method, using the dropwise addition by syringe pump (0.5 mL/min). The shell growth was controlled by monitoring the total addition time, and each reaction was continued for ˜1.5 min after addition was complete before the power was turned off. A total reaction time of 7.5 min yielded a shell thickness of 0.6 nm, while the thickest shell of 2.7 nm was obtained after 12.5 min. The FePt@Co core-shell nanoparticles were worked up in a similar fashion as described above for the FePt cores.

### Example 2

### Methods

Infra-red (IR) spectroscopy was performed on a PerkinElmer Spectrum 100 FT-IR spectrometer. The particles were mixed with a minimal amount of KBr and analyzed as solid samples.

Scanning Transmission Electron Microscopy (STEM) was performed on a Titan TEM instrument at 200 kV accelerating voltage. The samples were dropcast from dispersion in toluene onto 200 mesh copper grids and left to dry under reduced pressure overnight.

Powder X-ray diffraction (pXRD) was performed on a Rigaku Ultima III diffractometer using a Cu—Kαsource and a micro area attachment. Data were collected at room temperature, in the 2θ range of 10-80° over the course of 30 minutes.

Magnetic measurements were performed on a superconducting quantum interference device (SQUID) magnetometer, MPMS-XL (Quantum Design). Samples were placed in a gelatin capsule and covered with 1-eicosene wax to prevent reorientation of particles under magnetic field during the measurements. Zero-field-cooled and field-cooled temperature sweeps were performed in an applied field of 10 mT. Field-dependent studies were recorded at 5 K, with the applied field varying from −5 to 5 T.

Thermogravimetric analysis was performed on a TA instruments SDT Q600 thermal analyzer. Measurements were done from 30 to 900° C. at a heating rate of 5° C./min.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. An article comprising:
a core region comprising an alloy of iron and platinum;
a shell region in contact with the core region, the shell region comprising cobalt.

2. The article of claim 1 wherein the core region consists essentially of an alloy of iron and platinum.

3. The article of claim 1 wherein the core region consists of an alloy of iron and platinum.

4. The article of claim 1 wherein the alloy of iron and platinum has the general formula Fe₁₋ₓPtₓ, wherein x has a value between about 0.3 and about 0.7.

5. The article of claim 1 wherein the alloy of iron and platinum has the general formula Fe₁₋ₓPtₓ, wherein x has a value between about 0.3 and about 0.4.

6. The article of claim 1 wherein the alloy of iron and platinum has the general formula Fe_{0.65}Pt_{0.35}.

7. The article of claim 1 wherein the core region comprises face centered cubic crystals.

8. The article of claim 1 wherein the core region comprises face centered tetragonal crystals.

9. The article of claim 1 having a shape selected from the group consisting of sphere, bar, cone, sheet, and rod.

10. The article of claim 1 having a shape comprising a sphere, wherein the core region has a diameter between about 2 nanometers and about 8 nanometers.

11. The article of claim 1 having a shape comprising a sphere, wherein the core region has a diameter between about 4 nanometers and about 6 nanometers.

12. The article of claim 1 having a shape comprising a sphere, wherein the shell region has a thickness between about 0.5 nanometers and about 2.5 nanometers.

13. The article of claim 1 having a shape comprising a sphere, wherein the shell region has a thickness between about 0.5 nanometers and about 1.0 nanometer.

14. A magnet comprising a hard magnetic core region and a soft magnetic shell region, wherein the hard-magnet core region comprises and alloy of iron and platinum has the general formula Fe₁₋ₓPtₓ, wherein x has a value between about 0.3 and about 0.7, and the soft-magnet shell region comprises cobalt.

15. A method of preparing a particle, the particle comprising a core region comprising an alloy of iron and platinum and a shell region comprising cobalt in contact with the core region, the shell region comprising cobalt, the method comprising:
preparing a mixture comprising a platinum precursor, an iron precursor, and an organic solvent system;
irradiating the mixture with microwave radiation, to thereby prepare the core region comprising the alloy of iron and platinum;
adding a cobalt precursor to the mixture; and
irradiating the mixture with microwave radiation to thereby deposit cobalt on the core region comprising the alloy of iron and platinum and to form the shell region comprising cobalt.

16. The method of claim 15 wherein the platinum precursor is selected from the group consisting of PtCl₂, Pt(NH₃)₄(NO₃)₂, Pt(acac)₂, and any combination thereof.

17. The method of claim 15 wherein the iron precursor is selected from the group consisting of Fe(CO)₅, Fe₂(CO)₉, Fe₃(CO)₁₂, and any combination thereof.

18. The method of claim 15 wherein the cobalt precursor is selected from the group consisting of Co₂(CO)₈, Co(acac)₂, CoCl₂, and any combination thereof.

19. The method of claim 15 wherein the organic solvent system comprises oleylamine, oleic acid, octadecene, polyvinylpropylene, hexadecylamine, and any combination thereof.

20. The method of claim 15 wherein the cobalt is deposited one atomic monolayer at a time onto the core region comprising the alloy of iron and platinum.

21. The method of claim 15 wherein the cobalt is deposited onto the core region comprising the alloy of iron and platinum in a layer by layer method, wherein each layer is between about 0.3 nanometer and about 0.7 nanometer thick.

22. The method of claim 15 wherein the cobalt is deposited onto the core region comprising the alloy of iron and platinum in a layer by layer method, wherein each layer is about 0.5 nanometer thick.

23. The method of claim 15 wherein the shell region comprising cobalt is less than 3 nanometers thick.

24. The method of claim 15 wherein the shell region comprising cobalt is less than 2 nanometers thick.

25. The method of claim 15 wherein the shell region comprising cobalt is less than 1 nanometer thick.

26. A method of preparing a particle, the particle comprising a core region comprising an alloy of iron and platinum and a shell region comprising cobalt in contact with the core region, the shell region comprising cobalt, the method comprising:
contacting a core particle comprising an alloy or iron and platinum with a cobalt precursor in a solvent; and
irradiating the formed magnetic core with microwave radiation to thereby deposit cobalt on the core particle comprising the alloy of iron and platinum and to form the shell region comprising cobalt.
